(19) United States
(12) Patent Application Publication
(10) Pub. No.: US 2024/0186541 A1
(43) Pub. Date: Jun. 6, 2024

(54) METHOD AND SYSEM FOR HUMIDIFYING AN AIR SUPPLY OF A FUEL CELL FOR AIRCRAFT

(71) Applicants: Airbus Operations SAS, TOULOUSE (FR); Airbus Operations GmbH, HAMBURG (DE)

(72) Inventors: Theophile HORDE, TOULOUSE (FR); Paul-Emile ROUX, TOULOUSE (FR); Anthony ROUX, TOULOUSE (FR); Julien LE BAIL, TOULOUSE (FR); Ignacio DURAN, TOULOUSE (FR); Guido KLEWER, HAMBURG (DE); Hendrik STRUMMEL, HAMBURG (DE)

(21) Appl. No.: 18/527,571

(22) Filed: Dec. 4, 2023

(30) Foreign Application Priority Data
Dec. 6, 2022 (FR) 2212849

(51) Int. Cl. H01M 8/04119; H01M 8/04111; H01M 8/04537; H01M 8/04746

(52) U.S. Cl. CPC H01M 8/04141; H01M 8/04111; H01M 8/04552; H01M 8/04582; H01M 8/04611; H01M 8/04753; H01M 8/04761; B64D 27/355

(57) ABSTRACT

A method for humidifying an air supply of a fuel cell, an air supply circuit including an injection line, an intermediate line and an evacuation line. The method includes steps for recovering recycled air, in the evacuation line, and injecting recycled air into the injection line so as to mix it with ambient air from the environment. The method additionally includes increasing the ratio of recycled air in the injection line when a power setting of the cell reduces and if the power setting is lower than a predefined power threshold, and reducing the ratio of recycled air when the power setting increases and if the power setting remains lower than the predefined threshold.

### CROSS-REFERENCES TO RELATED APPLICATIONS

This application claims the benefit of the French patent application No. 2212849 filed on Dec. 6, 2022, the entire disclosures of which are incorporated herein by way of reference.

### FIELD OF THE INVENTION

The present invention relates to the field of air supply of fuel cells, and more particularly, a system intended to humidify the air supply of a fuel cell in an aircraft, in particular of a fuel cell electrically powering an electric propulsion motor of the aircraft.

### BACKGROUND OF THE INVENTION

The operation of the fuel cell requires an air supply at the cathode. The air for such a supply is generally humidified at the inlet of the fuel cell in order to improve the performance of the fuel cell.

Furthermore, to prevent accelerating deterioration of the fuel cell and thus prevent a shortening of the life of the fuel cell, it is preferable to prevent the voltage supplied across the terminals of a fuel cell from exceeding a maximum voltage limit, which is generally of the order of 850 mV. Due to the inherent characteristics of the fuel cell, this maximum voltage limit means that it is impossible to make the fuel cell operate below a minimum power limit. Indeed, the voltage across the terminals of the fuel cell reduces as the current increases. Moreover, when the current supplied by the fuel cell is lower than a current threshold value, the power (product of voltage and the current) supplied by the cell increases when the current supplied by the cell increases. The minimum power limit of the fuel cell therefore depends on the fuel cell dimensioning parameters and corresponds to the minimum power attainable by the fuel cell when the voltage supplied by the cell reaches the maximum voltage limit.

Such a minimum power limit is problematic for achieving a low-power operation of the fuel cell, for example when used in a low-power regime such as an idling phase of a motor of the aircraft powered by the fuel cell, while keeping the lifetime acceptable.

A first conceivable solution for achieving a low-power regime operation is to deliberately reduce the performance of the fuel cell by acting on external parameters, such as the pressure or concentration of gases sent into the fuel cell, or the temperature of the fuel cell. The efficiency of the fuel cell is thus reduced and it is hence possible to achieve low-power operation of the fuel cell without exceeding the maximum voltage limit. However, this solution does not provide for achieving optimum performance in a nominal operation regime, in which the power levels required from the fuel cell are higher. The efficiency of the fuel cell is found to be reduced.

It is hence desirable to address these drawbacks of the prior art.

It is notably desirable to provide a solution which results in achieving a low-power operation of the fuel cell while preserving a voltage across the terminals of the fuel cell that is lower than the maximum voltage limit, so as to prevent degradation of the fuel cell and reduction of its life. It is furthermore desirable to provide a solution which results in preserving optimum efficiency of the fuel cell in standard operating phases (e.g., cruising flight, etc.) at nominal power levels. It is lastly desirable to provide a solution that is easy to implement, inexpensive and compact.

### SUMMARY OF THE INVENTION

An object of the present invention is to propose a method for managing humidification of an air supply of a fuel cell for an aircraft, an air supply circuit of the fuel cell including an injection line, an intermediate line passing through a cathode of the fuel cell, and an evacuation line, the air flowing in a predefined direction in the supply circuit, passing successively through the injection line, the intermediate line and the evacuation line. The method includes the steps of: recovering the air, referred to as “recycled air”, from the fuel cell, in the evacuation line; injecting into the injection line the recovered recycled air so as to mix the recycled air with ambient air. The method additionally includes increasing the ratio of recycled air relative to ambient air in the injection line:
when a power or current setting of the fuel cell reduces and if additionally the power or current setting is lower than a predefined threshold, or
when a voltage supplied by the fuel cell reaches or rises above a maximum authorized voltage limit.

The method additionally includes reducing the ratio of recycled air relative to ambient air in the injection line:
when the power or current setting increases and if additionally the power or current setting remains lower than the predefined threshold, or
when the voltage supplied by the fuel cell falls below a maximum authorized voltage limit.

It is thus possible to temporarily increase the water concentration and reduce the dioxygen concentration of the air injected into the intermediate line in order to deliberately degrade the performance of the fuel cell. A low-power operation can thus be easily achieved without exceeding a maximum authorized voltage limit of the fuel cell. Moreover, it is possible to reverse the deliberate degradation of performance of the fuel cell by reducing the water concentration and increasing the dioxygen concentration of the air injected into the intermediate line, and thus increase efficiency when the fuel cell is operating at nominal power levels. Furthermore, the deliberate degradation of performance of the fuel cell can be tailored to various power ranges, thus enabling the best efficiency possible to be achieved while preserving a voltage supplied by the fuel cell that is lower than the maximum authorized voltage limit.

According to a particular embodiment, injecting the recycled air into the injection line is done at the inlet of a compressor located on the injection line.

According to a particular embodiment, injecting the recycled air into the injection line is done between the two stages of a two-stage compressor, the compressor being located on the injection line.

According to a particular embodiment, the injection line includes a humidifier configured to allow an exchange of water between the air flowing in the evacuation line and the air flowing in the injection line, and the step of injecting, into the injection line, the recovered recycled air so as to mix the recycled air with ambient air, is carried out only when the power or current setting is lower than a predefined threshold, or when a voltage supplied by the fuel cell reaches or rises above the maximum authorized voltage limit.

According to a particular embodiment, the injection line includes a humidifier configured to allow an exchange of water between the air flowing in the injection line and the air flowing in the evacuation line. The step of recovering the recycled air in the evacuation line is carried out downstream of the humidifier on the evacuation line, and the step of injecting, into the injection line, the recovered recycled air so as to mix the recycled air with ambient air, is carried out only when the power or current setting is lower than a predefined threshold, or when a voltage supplied by the fuel cell reaches or rises above the maximum authorized voltage limit.

The invention relates also to an air supply circuit of a fuel cell for an aircraft, the air supply circuit being intended to humidify the air supplying the fuel cell. The air supply circuit includes: an injection line; an intermediate line passing through a cathode of the fuel cell; and an evacuation line. The air flows in a predefined direction in the supply circuit, passing successively through the injection line, the intermediate line and the evacuation line. The air supply circuit additionally includes a line, referred to as “recirculation line”, including: a first end connected to the evacuation line so as to recover air, referred to as “recycled air”, coming from the fuel cell; and a second end connected to the injection line, so as to inject, into the injection line, the recovered recycled air and mix the recycled air with ambient air. The air supply circuit is configured to increase the ratio of recycled air relative to ambient air in the injection line:
when a power or current setting of the fuel cell reduces and if the power or current setting is lower than a predefined threshold, or
when a voltage supplied by the fuel cell reaches or rises above a maximum authorized voltage limit.

The supply circuit is additionally configured to reduce the ratio of recycled air relative to ambient air in the injection line:
when the power or current setting increases and if the power or current setting remains lower than the predefined threshold, or
when the voltage supplied by the fuel cell falls below the maximum authorized voltage limit.

According to a particular embodiment, the air supply circuit additionally includes: a first flow controller, located on the recirculation line, to control the flow rate of the recycled air; and a second flow controller, located on the injection line before the second end of the recirculation line with respect to the predefined air flow direction, to control the flow rate of the ambient air.

According to a particular embodiment, the injection line includes a compressor of ambient air, the second end of the recirculation line being connected to the injection line before the inlet of the compressor of ambient air.

According to a particular embodiment, the injection line includes a compressor of ambient air with two stages, the second end of the recirculation line being connected to the injection line between the two stages of the two-stage compressor of ambient air.

According to a particular embodiment, the injection line includes a humidifier configured to allow an exchange of water between the air flowing in the evacuation line and the air flowing in the injection line, and the recirculation line includes a valve, the valve being open only when the power or current setting is lower than a predefined threshold, or when the voltage supplied by the fuel cell reaches or rises above a maximum authorized voltage limit.

According to a particular embodiment, the injection line includes a humidifier configured to allow an exchange of water between the air flowing in the injection line and the air flowing in the evacuation line; the first end of the recirculation line is located downstream of the humidifier and the recirculation line includes a valve, the valve being open only when the power or current setting is lower than a predefined threshold, or when the voltage supplied by the fuel cell reaches or rises above the maximum authorized voltage limit.

The invention relates also to an aircraft including an air supply circuit as mentioned above in any one of its embodiments.

There is also proposed a computer program product, which can be stored on a medium and/or downloaded from a communication network, in order to be read by a processor. This computer program contains instructions to implement the abovementioned method in any one of its embodiments, when the computer program is executed by the processor. The invention relates also to a data storage medium storing a computer program containing instructions to implement the abovementioned method in any one of its embodiments when the computer program is read from the storage medium and executed by the processor.

### BRIEF DESCRIPTION OF THE DRAWINGS

The abovementioned features of the invention, as well as others, will become clearer upon reading the following description of at least one example embodiment, the description being made with reference to the appended drawings, in which:

FIG. 1 schematically illustrates an aircraft including an air supply circuit of a fuel cell;

FIG. 2 schematically illustrates the air supply circuit according to a first embodiment;

FIG. 3 schematically illustrates the air supply circuit according to a second embodiment;

FIG. 4 schematically illustrates the air supply circuit according to a third embodiment;

FIG. 5 schematically illustrates a hardware architecture of a control unit of the air supply circuit;

FIG. 6 schematically illustrates a method for managing the humidification of an air supply circuit of a fuel cell, according to one embodiment;

FIG. 7 schematically illustrates a method for managing the humidification of an air supply circuit of a fuel cell, according to another embodiment;

FIG. 8 schematically illustrates the air supply circuit according to a fourth embodiment; and

FIG. 9 schematically illustrates the air supply circuit 2 according to a fifth embodiment.

### DETAILED DESCRIPTION OF THE PREFERRED EMBODIMENTS

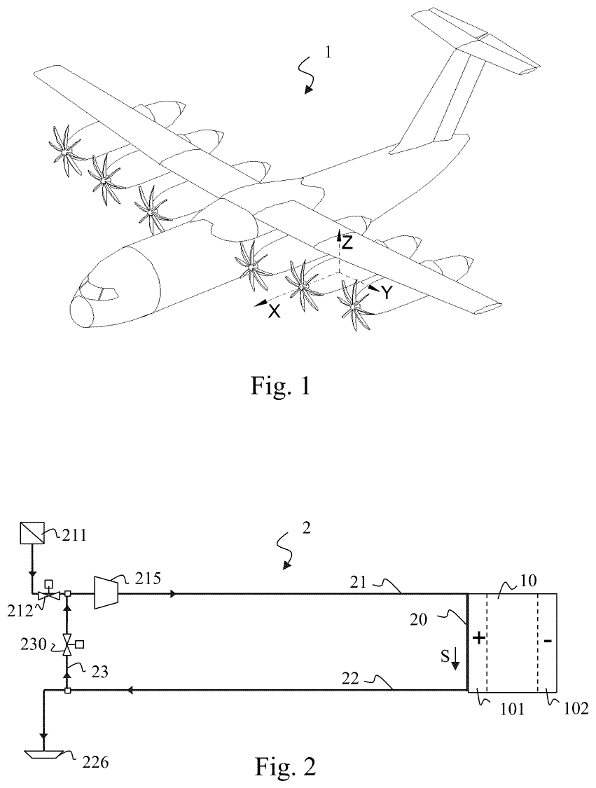

FIG. 1 thus schematically illustrates an aircraft 1 including at least one fuel cell 10, and an air supply circuit 2 of the fuel cell 10. The aircraft 1 includes at least one electric motor configured to rotationally drive a propeller for the propulsion of the aircraft 1, each electric motor being supplied with electricity by at least one fuel cell 10. An electric motor supplied with electricity by at least one fuel cell 10 can additionally, or alternatively, be used to supply current for equipment on board the aircraft 1.

FIG. 2 schematically illustrates the air supply circuit 2 according to a first embodiment. In FIG. 2, the air supply circuit 2 is configured to supply air to a fuel cell 10, which includes a cathode 101 and an anode 102. For the fuel cell 10 to operate and produce electricity, the anode 102 must be supplied with dihydrogen and the cathode 101 with dioxygen.

The air supply circuit 2 includes an intermediate line 20, an injection line 21 and an evacuation line 22.

The air flows in a predefined direction S in the intermediate line 20, and thus flows successively through the injection line 21, the intermediate line 20 and then the evacuation line 22.

The intermediate line 20 passes through the cathode 101 of the fuel cell 10 so as to allow a part of the dioxygen in the air flowing in the intermediate line 20 to pass to the cathode 101. The air flowing in the intermediate line 20 thus provides for supplying gaseous dioxygen to the cathode 101 in order to ensure a chemical reaction necessary for the production of electricity from the fuel cell 10. The air flowing in the intermediate line 20 is therefore rarefied of dioxygen as it travels through the intermediate line 20 and is loaded with water molecules from the chemical reaction.

The injection line 21 is configured to bring ambient air, from the environment to the intermediate line 20. The injection line 21 includes, at its inlet, a filter 211 intended to filter out particles and/or chemical elements of the air from the environment, thereby purifying the ambient air flowing into the injection line 21.

The evacuation line 22 is for evacuating the air from the fuel cell 10, referred to as “exhaust air”, from the intermediate line 20 to the outside of the aircraft 1. The exhaust air is evacuated via an exhaust pipe 226 arranged at the outlet of the evacuation line 22, in other words arranged, at an end of the evacuation line 22 opposite the intermediate line 20.

The air supply circuit 2 additionally includes a recirculation line 23. The recirculation line 23 is connected at a first end to the evacuation line 22 and at a second end to the injection line 21. The recirculation line 23 thus provides for recovering, from the evacuation line 22, a part of the exhaust air from the fuel cell 10, in order to inject it into the injection line 21. The exhaust air thus reinjected into the injection line 21 is referred to as “recycled air”, and is mixed with ambient air. This provides a humidifying effect and reduces the concentration of dioxygen in the air sent into the intermediate line 20.

The injection line 21 includes a compressor 215 enabling the pressure of the ambient air to be increased and activating circulation of the air through the air supply circuit. The compressor 215 is located after the second end of the recirculation line 23. It is hence unnecessary to use a dedicated compressor for pressurizing the recycled air before injecting it into the injection line. The air supply circuit is therefore simplified.

The recirculation line 23 includes a first flow controller 230, such as an electrovalve, for adjusting the flow rate of recycled air injected into the injection line 21.

The injection line 21 includes a second flow controller 212, such as an electrovalve, for adjusting the flow rate of ambient air flowing into the injection line 21. The second flow controller 212 is positioned before, in other words, upstream of the junction with the recirculation line 23 relative to the air flow direction. Put another way, the second flow controller 212 is located between the ambient air inlet of the injection line 21 and the second end of the recirculation line 23, so as to control only the flow rate of the ambient air from the environment.

The air supply circuit 2 additionally includes a control unit 500 (not represented in FIG. 2). The control unit 500 is capable of sending instructions to the first flow controller 230 and to the second flow controller 212 in order to make the proportion of recycled air relative to ambient air, i.e., the ratio of recycled air, vary in the injection line 21.

The recycled air has a higher water concentration and a lower dioxygen concentration than the ambient air. The control unit 500 can send instructions to the first and second flow controllers 230, 212, so as to increase the ratio of recycled air, thus having the effect of increasing the water concentration and reducing the dioxygen concentration of the air injected into the intermediate line 20. The performance of the fuel cell is hence degraded, thereby achieving a low-power operation without a maximum authorized voltage limit of the fuel cell 10 being exceeded. The fuel cell 10 can thus be operated in an idling phase while avoiding accelerating the degradation of the fuel cell 10.

Conversely, the control unit 500 can reduce the water concentration and increase the dioxygen concentration of the air injected into the intermediate line 20 by sending instructions to the first and second flow controllers 230, 212 so as to reduce the ratio of recycled air. The performance of the fuel cell 10 is thus improved when the power required from the fuel cell 10 increases, and high efficiency can be achieved in a standard operating phase (cruising flight, etc.), i.e., for operation at nominal power levels.

The ratio of recycled air can be reduced down to a predefined value, which is calculated to obtain optimal efficiency of the fuel cell 10 in a standard operating phase in which the power levels supplied by the fuel cell 10 are higher than those required during an idling phase.

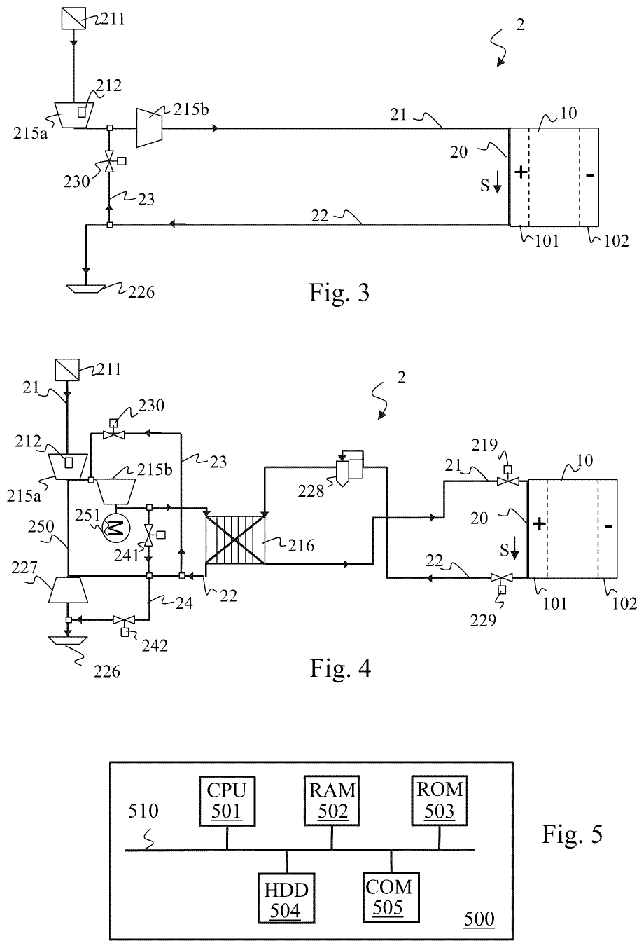

FIG. 3 schematically illustrates the air supply circuit 2 according to a second embodiment.

According to the second embodiment, the injection line 21 includes a two-stage compressor 215a, 215b, which replaces the compressor 215 of the first embodiment. The second end of the recirculation line 23 joins the injection line 21 between a first stage 215a and a second stage 215b of the compressor.

The first stage 215a of the compressor is for pressurizing and heating the ambient air before the recycled air mixes with the ambient air. The ambient air is taken from the external environment at low temperature and low pressure, at a pressure of the order of 0.3 to 0.5 bar. The recycled air for its part comes from the fuel cell 10 at a much higher pressure than the pressure of the air from the environment, typically of the order of 2 to 2.5 bar, and at a higher temperature than the air from the environment. The first stage 215a of the compressor therefore provides for, on the one hand, reducing the pressure gradient between the ambient air and the recycled air, and on the other hand, reducing the temperature difference between the ambient air and the recycled air. Thus, mixing of the recycled air and ambient air is facilitated, and condensation of water is prevented which could arise when recycled air, which is hot and with a high water concentration, comes into contact with the cooler ambient air.

According to the second embodiment, the second flow controller 212 is integrated with the first stage 215a of the compressor.

FIG. 4 schematically illustrates the air supply circuit 2 according to a third embodiment.

According to the third embodiment, the injection line 21 includes, in addition to the filter 211, the two-stage compressor 215a and 215b and the second flow controller 212 integrated with the first stage 215a of the compressor, a valve 219 located just before the intermediate line 20 in the air flow direction S. The evacuation line 22 includes a valve 229 located just after the intermediate line 20 in the air flow direction S. The valves 219 and 229 are for isolating the fuel cell 10 from the air supply circuit 2 when the fuel cell 10 is stopped. The evacuation line 22 additionally includes a water collector 228 located after the valve 229 in the air flow direction S, and enabling collection of the water in the form of liquid present in the exhaust air. Indeed, the exhaust air contains a significant concentration of water able to reach saturation of water in gaseous form. The water collector 228 thus separates the liquid and gaseous phases present in the exhaust air.

The injection line 21 and the evacuation line 22 each pass through a heat exchanger 216, also called a cooler. The heat exchanger 216 is located on the injection line 21 after the second stage 215b of the compressor and before the valve 219 in the air flow direction S. The heat exchanger 216 is located on the evacuation line 22 after the water collector 228 and before the first end of the recirculation line 23 in the air flow direction S.

The evacuation line 22 additionally includes, between the first end of the recirculation line 23 and the exhaust pipe 226, a turbine 227. The turbine 227 has the effect of expanding the exhaust air and thus, by reducing the pressure of the exhaust air, provides for retrieving energy which can be reused. The energy supplied by the turbine 227 can, for example, be used to operate the first stage of the compressor 215a by means of a link 250. In parallel, the second stage 215b of the compressor is, for example, powered by a motor 251.

The air supply circuit 2 includes a bypass line 24. A first portion of the bypass line 24 connects the injection line 21, in an area located between the second stage 215b of the compressor and the heat exchanger 216, to the evacuation line 22, in an area located between the heat exchanger 216 and the turbine 227.

The first portion of the bypass line 24 includes a valve 241. When the valve 241 is open, ambient air is bypassed from the injection line 21 to the evacuation line 22 and therefore cannot flow into the intermediate line 20.

A second portion of the bypass line 24 connects the evacuation line 22, in an area located between the heat exchanger 216 and the turbine 227, to the evacuation line 22, in an area located between the turbine 227 and the exhaust pipe 226. The second portion of the bypass line 24 includes a valve 242. When the valve 242 is open, exhaust air is bypassed via the bypass line 24 and therefore does not flow through the turbine 227.

When the fuel cell 10 is in operation, the valves 241 and 242 are closed.

According to a fourth embodiment, the heat exchanger 216, the water collector 228, the valves 219 and 229, the turbine 227, and the bypass line 24 with the valves 241 and 242, can each be implemented on an air supply circuit 2 including a single compressor 215 as described according to the first embodiment in FIG. 2.

FIG. 5 schematically illustrates a hardware architecture of the control unit 500 of the air supply circuit 2.

The control unit 500 hence includes, connected by a communication bus 510: a processor or CPU (Central Processing Unit) 501; a RAM (Random-Access Memory) 502; a ROM (Read-Only Memory) 503; a storage unit or storage medium reader, such as an HDD (Hard Disk Drive) 504; and a communication interface COM 505 for communicating with the first flow controller 230, the second flow controller 212, and a voltage detector and/or a device transmitting a power or current setting for the fuel cell 10.

The processor 501 is capable of executing instructions loaded into the RAM 502 from the ROM 503, from an external memory (not represented), from a storage medium or from a communication network. When the control unit 500 is powered up, the processor 501 is capable of reading instructions from the RAM 502 and executing them. These instructions form a computer program bringing about the implementation, by the processor 501, of all or some of the algorithms and steps described here in relation to the control unit 500.

Thus, all or some of the algorithms and steps described in relation to the control unit 500 can be implemented in software form by the execution of a set of instructions by a programmable machine, such as a DSP (Digital Signal Processor) or a microcontroller, or be implemented in hardware form by a dedicated component or machine, such as an FPGA (Field-Programmable Gate Array) or an ASIC (Application-Specific Integrated Circuit). Generally, the control unit 500 includes electronic circuitry adapted and configured to implement the algorithms and steps described in relation to the control unit 500.

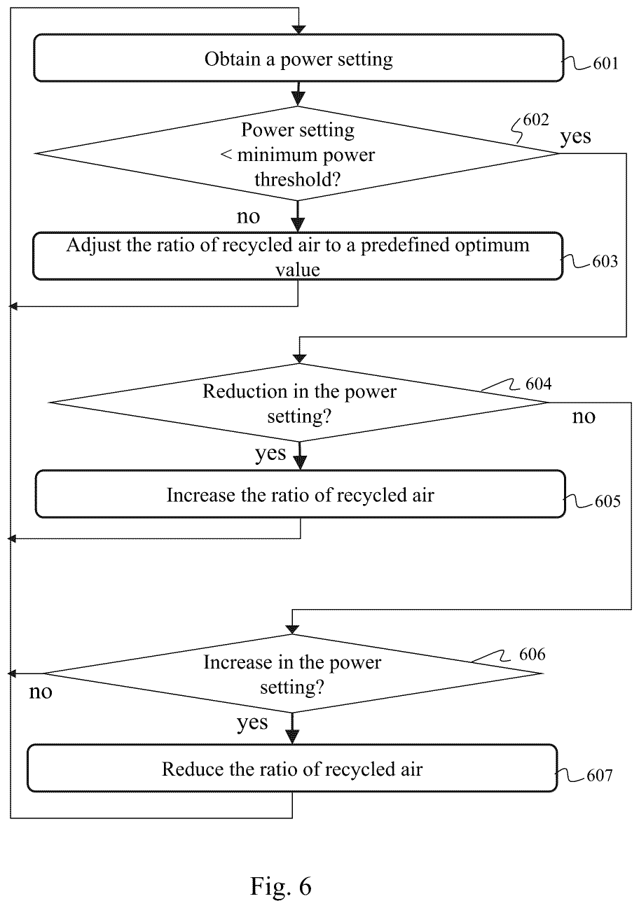

FIG. 6 schematically illustrates a method for managing the humidification of an air supply circuit of a fuel cell 10, in a particular embodiment.

In a first step 601, the control unit 500 obtains a power setting for the fuel cell 10 coming from a device transmitting a power setting for the fuel cell 10. The power setting comes from, for example, the avionics of the aircraft 1, or from a controller of an electric motor which the fuel cell 10 is electrically powering.

In a following step 602, the control unit 500 compares the power setting obtained with a predefined power threshold. The predefined power threshold is defined as being the minimum attainable power from the fuel cell 10 when the voltage supplied by the fuel cell 10 is lower than the maximum authorized voltage limit, and under conditions enabling maximum efficiency to be achieved at nominal operating power levels, i.e., for a ratio of recycled air equal to the predefined value. The predefined power threshold is, for example, determined beforehand by measuring the power supplied by the fuel cell 10 when the maximum authorized voltage limit is reached, for defined operating conditions of pressure, temperature and gas concentration. Alternatively, the predefined power threshold is determined during operation of the fuel cell 10 when the voltage supplied by the fuel cell 10 reaches the maximum authorized voltage limit. If the power setting is greater than the predefined power threshold, then the control unit 500 carries out a step 603. Otherwise, the control unit 500 carries out a step 604.

Thus, when the power setting, i.e., the power required from the fuel cell 10, decreases to below the predefined power threshold, the control unit 500 detects that the fuel cell 10 is entering an idling phase. On the other hand, if the power setting remains at or passes above the predefined power threshold, the control unit 500 detects that the fuel cell 10 is in a standard operating phase.

At step 603, the control unit 500 adjusts the ratio of recycled air, i.e., the proportion of recycled air relative to ambient air, in the injection line 21 to a predefined value suitable for the standard operating phase, i.e., for operation at nominal power levels. To this end, the control unit 500 sends an instruction to the first flow controller 230 containing a recycled air flow rate value, and an instruction to the second flow controller 212 containing an ambient air flow rate value, such that the flow rate of recycled air injected into the injection line 21 relative to the flow rate of ambient air flowing into the injection line 21 is equal to the predefined value.

The control unit 500 retrieves a value for the total air flow rate to be injected into the intermediate line 20. The total air flow rate value is, for example, a predetermined flow rate value, configured and saved in the control unit 500. According to another example, the total air flow rate value is calculated regularly during operation of the fuel cell 10 taking account of the current delivered by the fuel cell 10, and then transmitted to the control unit 500. The control unit 500 calculates the recycled air flow rate on the one hand, and the ambient air flow rate on the other hand, as a function of the ratio of recycled air and such that the sum of the recycled air flow rate and the ambient air flow rate is equal to the total air flow rate.

The control unit 500 saves into memory the setting value obtained previously at step 601, and then returns to step 601 to obtain a new power setting.

Thus, when the fuel cell 10 is in a standard operating phase, the air injected into the fuel cell 10 has a moisture content enabling optimal efficiency of the fuel cell 10 to be achieved for a useful power range, while minimizing consumption of dihydrogen.

At step 604, the control unit 500 determines whether the power setting obtained reduces relative to a previous setting value obtained. The previous setting value is, for example, saved in the memory of the control unit 500. If the power setting obtained is lower than the previous setting value, the control unit 500 carries out a step 605. Otherwise, the control unit 500 carries out a step 606.

At step 605, the control unit 500 increases the ratio of recycled air in the injection line 21. To this end, the control unit 500 sends an instruction to the first flow controller 230 containing a recycled air flow rate value, and an instruction to the second flow controller 212 containing an ambient air flow rate value, such that the flow rate of recycled air injected into the injection line 21 increases relative to the flow rate of ambient air flowing into the injection line 21. The ratio of recycled air can be calculated as a function of the value of the power setting or as a function of the reduction of the power setting and taking account of characteristic parameters of the fuel cell 10 and of the air supply circuit 2. Such a calculation of the ratio of recycled air can, for example, be performed using empirical data.

When the fuel cell 10 is in an idling phase, the ratio of recycled air then increases if the power setting is reduced. The increase in the concentration of dioxygen in the air sent to the cathode 101 thus provides for lowering the minimum power attainable by the fuel cell 10 while remaining below the maximum authorized voltage limit.

The control unit 500 then saves into memory the setting value obtained previously at step 601 in order to be able to compare it with a new setting value, and then returns to step 601.

At step 606, the control unit 500 determines whether the power setting obtained increases relative to a previous setting value obtained. If that is the case, the control unit 500 carries out a step 607. Otherwise, the control unit 500 saves into memory the setting value obtained previously at step 601 in order to be able to compare it with a new setting value, and then returns to step 601.

At step 607, the control unit 500 reduces the ratio of recycled air in the injection line 21. To this end, the control unit 500 sends an instruction to the first flow controller 230 containing a recycled air flow rate value, and an instruction to the second flow controller 212 containing an ambient air flow rate value, such that the flow rate of recycled air injected into the injection line 21 reduces relative to the flow rate of ambient air flowing into the injection line 21. As previously, the ratio of recycled air can be calculated as a function of the value of the power setting or of the increase in the power setting, and taking account of characteristic parameters of the fuel cell 10 and of the air supply circuit 2, for example using empirical data.

When the fuel cell 10 is in the idling phase, the ratio of recycled air reduces if the power setting increases, thus providing for adapting the dioxygen concentration in the air sent to the cathode 101 in order to obtain the power required from the fuel cell 10 without exceeding the maximum authorized voltage limit and while optimizing consumption of dihydrogen.

The control unit 500 saves into memory the setting value obtained previously at step 601 in order to be able to compare it with a new setting value, and then returns to step 601.

According to an alternative embodiment, the method for managing the humidification of the air supply of the fuel cell 10 provides for obtaining a current setting rather than a power setting at step 601, the current setting being obtained from a device transmitting a current setting for the fuel cell 10. The method for managing the humidification of the air supply implements steps 602 to 607 using the current setting obtained and calling upon, at step 602, a predefined current threshold instead of the predefined power threshold.

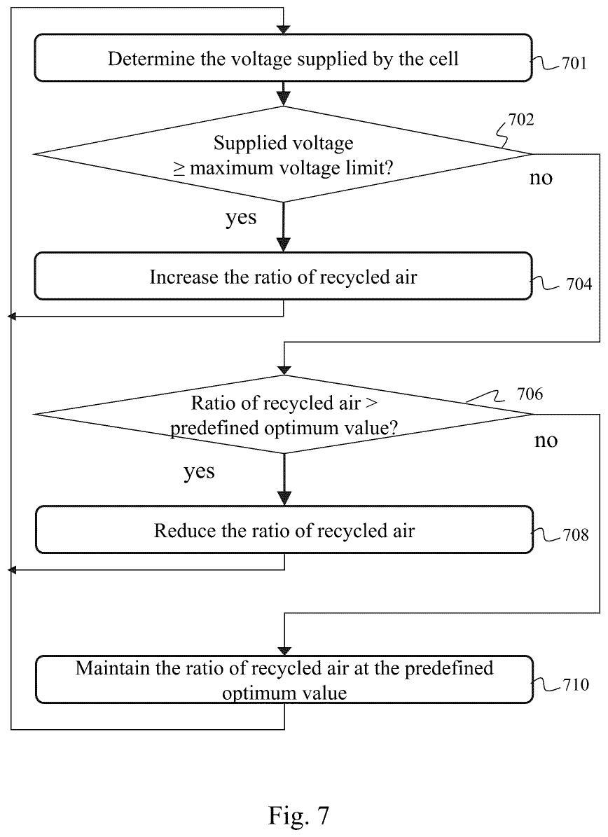

FIG. 7 schematically illustrates a method for managing the humidification of an air supply of a fuel cell 10, in another particular embodiment.

In a first step 701, the control unit 500 determines the voltage supplied by the fuel cell 10, i.e., the voltage delivered across the terminals of the fuel cell 10, by means of a voltage detector.

In a following step 702, the control unit 500 compares the voltage supplied with the maximum authorized voltage limit. If the supplied voltage reaches or exceeds the maximum authorized voltage limit, then a step 704 is carried out. Otherwise, a step 706 is carried out.

At step 704, the control unit 500 increases the ratio of recycled air. The control unit 500 sends an instruction to the first flow controller 230 containing a recycled air flow rate value, and an instruction to the second flow controller 212 containing an ambient air flow rate value, such that the flow rate of recycled air injected into the injection line 21 increases relative to the flow rate of ambient air flowing into the injection line 21. The control unit 500 then returns to step 701.

At step 706, the control unit 500 determines whether the ratio of recycled air is higher than a predefined value. If that is the case, a step 708 is carried out. Otherwise, a step 710 is carried out.

At step 708, the control unit 500 reduces the ratio of recycled air. The control unit 500 sends an instruction to the first flow controller 230 containing a recycled air flow rate value, and an instruction to the second flow controller 212 containing an ambient air flow rate value, such that the flow rate of recycled air injected into the injection line 21 reduces relative to the flow rate of ambient air flowing into the injection line 21. Additionally, the ratio of recycled air is reduced down to a predefined value, the predefined value corresponding to the ratio of recycled air enabling the best possible efficiency to be achieved for the fuel cell 10 in a standard operating range, i.e., for operation at a nominal power level. The control unit 500 then returns to step 701.

At step 710, the control unit 500 maintains the ratio of recycled air at the predefined value.

Thus, when the voltage supplied by the fuel cell 10 reaches or crosses the maximum authorized voltage limit, the reduction in the ratio of recycled air provides for lowering the supplied voltage and thus preventing an acceleration of the degradation of the fuel cell 10.

It is additionally possible to actively adapt the ratio of recycled air in order to obtain the best possible efficiency in various power ranges of the fuel cell 10.

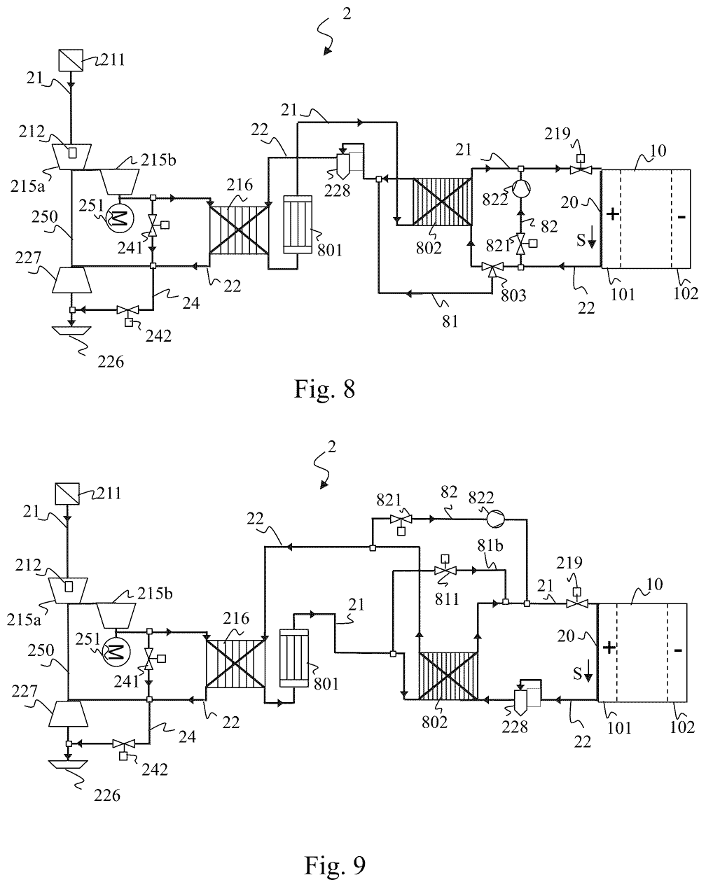

FIG. 8 schematically illustrates the air supply circuit 2 according to a fourth embodiment.

The air supply circuit 2 according to the fourth embodiment includes the injection line 21, the filter 211, the two-stage compressor 215a, 215b, the heat exchanger 216, the valve 219, the intermediate line 20, the evacuation line 22, the water collector 228, the turbine 227, the exhaust pipe 226 and the bypass line 24 including the valves 241 and 242, as described in the third embodiment.

The air supply circuit 2 according to the fourth embodiment additionally includes an additional heat exchanger 801, a humidifier 802, a bypass line 81, a three-way valve 803 and a recirculation line 82 including a valve 821 and a pump 822. The air supply circuit 2 does not include, according to the fourth embodiment, the recirculation line 23.

Hereafter in the description, the additional heat exchanger 801 is referred to as the second heat exchanger and the heat exchanger 216 described previously in relation to the third embodiment is referred to as the first heat exchanger 216. The line 81 is referred to as the second bypass line 81 and the bypass line 24 described previously in relation to the third embodiment is referred to as the first bypass line 24.

The recirculation line 82 is connected at a first end to the evacuation line 22 and at a second end to the injection line 21. According to the fourth embodiment, the recirculation line 82 connects the evacuation line 22, in an area located between the outlet of the intermediate line 20 and the three-way valve 803, to the injection line 21, in an area located between the humidifier 802 and the valve 219. In the recirculation line 82, the air first flows through the valve 821 and then passes through the pump 822 which generates a flow movement towards the injection line 21.

The recirculation line 82 provides for recovering from the evacuation line 22 all or part of the exhaust air from the fuel cell 10, in order to inject it into the injection line 21. The exhaust air thus reinjected into the injection line 21 is referred to as “recycled air”, and is mixed with the ambient air.

The pump 822 additionally provides for controlling the flow rate of recycled air and therefore the dioxygen concentration of the air sent into the intermediate line 20. The pump therefore fulfils the role of the first flow controller 230.

The valve 821 is for allowing or blocking the passage of air into the recirculation line 82. In a standard operating phase, the valve 821 is closed and air does not flow in the recirculation line 82. The air sent to the intermediate line 20 is humidified, the humidification being controlled by the humidifier 802. On the other hand, in a low-power operating phase, the valve 821 is open, and recycled air is mixed with ambient air in order to reduce the dioxygen concentration of the air sent into the intermediate line 20 and to obtain a low-power operation of the fuel cell 10 while remaining under the maximum authorized voltage limit. The air sent into the intermediate line 20 is humidified both by the humidifier 802 and by the presence of recycled air.

The second heat exchanger 801 is located on the injection line 21 after the first heat exchanger 216 in the air flow direction S. The second heat exchanger 801 is for cooling the air flowing in the injection line 21 by an exchange of heat with a coolant flowing in the second heat exchanger 801. The second heat exchanger 801 means that the volume of the first heat exchanger 216 can be reduced while ensuring that the temperature of air entering the intermediate line 20 is suitable for the operation of the fuel cell 10.

The injection line 21 and the evacuation line 22 pass through the humidifier 802 and cross one another so as to allow exchange of water molecules from the air flowing in the evacuation line 22 to the air flowing in the injection line 21. The exchange of water is made possible by the presence of a membrane permeable to water, such as a porous material. The humidifier 802 is located on the injection line 21 after the second heat exchanger 801 and before a junction with the recirculation line 82 in the air flow direction S. The humidifier 802 is located on the evacuation line 22 after the three-way valve 803 and before the water collector 228 in the air flow direction S. The humidifier 802 provides for increasing and controlling the water concentration of the air sent into the intermediate line 20.

A second bypass line 81 connects the three-way valve 803 on the evacuation line 22, in an area located upstream of the humidifier 802, to the evacuation line 22, in an area located between the humidifier 802 and the water collector 228. The second bypass line 81 thus provides for preventing air flowing in the evacuation line 22 from flowing through the humidifier 802.

The three-way valve 803 is located on the evacuation line 22 after the outlet of the intermediate line 20 in the air flow direction S. The three-way valve 803 has four positions. In a first position, the three-way valve 803 is closed, thus providing for isolating the fuel cell 10 when the fuel cell 10 is stopped. The three-way valve 803 hence fulfils the role of the valve 229 described in the third embodiment.

In a second position, the three-way valve 803 provides for making the air from the intermediate line 20 to flow to the second bypass line 81 and prevent it from passing through the humidifier 802. This has the effect of emptying the humidifier 802 and in particular removing water in liquid form in order to prevent deterioration of the humidifier by the formation of ice when operating conditions are at negative temperatures. This is the case, for example, when the fuel cell 10 is not operating or when it is starting up.

In a third position, the three-way valve 803 provides for making all the air from the intermediate line 20 to flow to the humidifier 802 and prevent it from passing through the second bypass line 81.

In a fourth position, the three-way valve 803 provides for making the air from the intermediate line 20 to flow both to the humidifier 802 and to the second bypass line 81. The three-way valve 803 can control the flow rate of air flowing to the humidifier 802 on the one hand, and flowing to the second bypass line 81 on the other hand. This hence provides for controlling the water concentration in the air flowing through the humidifier 802 and facilitating control of the humidification of the air sent to the intermediate line 20.

FIG. 9 schematically illustrates the air supply circuit 2 according to a fifth embodiment.

The air supply circuit 2 according to the fifth embodiment includes the injection line 21, the filter 211, the two-stage compressor 215a, 215b, the first heat exchanger 216, the second heat exchanger 801, the humidifier 802, the valve 219, the intermediate line 20, the evacuation line 22, the water collector 228, the recirculation line 82 including the valve 821 and the pump 822, the turbine 227, the exhaust pipe 226 and the bypass line 24 including the valves 241 and 242.

The air supply circuit 2 according to the fifth embodiment additionally includes a third bypass line 81b connecting the evacuation line 22, in an area located between the second heat exchanger 801 and the humidifier 802, to the injection line 21, in an area located between the humidifier 802 and the valve 219. The third bypass line 81b provides for preventing air flowing in the injection line 21 from flowing through the humidifier 802. This has the effect of emptying the humidifier 802 and, in particular, removing water in liquid form in order to prevent deterioration of the humidifier 802 by the formation of ice when operating conditions are at negative temperatures.

According to the fifth embodiment, the water collector 228 is located upstream of the humidifier 802, i.e., between the outlet of the intermediate line 20 and the humidifier 802. Furthermore, the recirculation line 82 connects the evacuation line 22, in an area located between the humidifier 802 and the first heat exchanger 216, to the injection line 21, in an area located downstream of the humidifier 802, i.e., between the humidifier 802 and the valve 219.

The humidifier 802 is used to allow an exchange of water molecules from the air flowing in the evacuation line 22 to the air flowing in the injection line 21 and thus provides for, on the one hand, humidifying the air sent into the intermediate line 20 and, on the other hand, dehumidifying the air flowing in the evacuation line 22.

Since the first end of the recirculation line 82 is located downstream of the humidifier 802 on the evacuation line 22, the recycled air injected into the injection line 21 is thus depleted of water, thereby preventing degradations in the fuel cell 10 resulting from the presence of water while providing for reducing the concentration of dioxygen and operating at low power without reaching the maximum authorized voltage limit. This advantage is particularly beneficial when the fuel cell 10 operates at low temperature since the concentration of water generated by the fuel cell 10 is more significant. The positioning of the water collector 228 upstream of the humidifier 802 on the evacuation line 22 amplifies the depletion of water in the recycled air.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for managing humidification of air in an air supply of a fuel cell for an aircraft, an air supply circuit of the fuel cell including an injection line, an intermediate line passing through a cathode, and an evacuation line, the air flowing in a predefined direction in the air supply circuit, passing successively through the injection line, the intermediate line and the evacuation line, the method including steps for:
recovering the air, referred to as “recycled air”, from the fuel cell, in the evacuation line,
injecting into the injection line the recovered recycled air so as to mix the recycled air with ambient air,
increasing a ratio of recycled air relative to ambient air in the injection line when a power or current setting of the fuel cell reduces and if, additionally, said power or current setting is lower than a predefined threshold,
reducing the ratio of recycled air relative to ambient air in the injection line when the power or current setting increases and if additionally said power or current setting remains lower than the predefined threshold.

2. The method according to claim 1, wherein injecting the recycled air into the injection line is done at an inlet of a compressor located on the injection line.

3. The method according to claim 1, wherein injecting the recycled air into the injection line is done between two stages of a two-stage compressor, said compressor being located on the injection line.

4. The method according to claim 1,
wherein the injection line includes a humidifier configured to allow an exchange of water between the air flowing in the evacuation line and the air flowing in the injection line, and
wherein the step of injecting, into the injection line, the recovered recycled air so as to mix the recycled air with ambient air, is carried out only when the power or current setting is lower than a predefined threshold.

5. The method according to claim 1,
wherein the injection line includes a humidifier configured to allow an exchange of water between the air flowing in the injection line and the air flowing in the evacuation line,
wherein the step of recovering the recycled air in the evacuation line is carried out downstream of the humidifier on the evacuation line, and
wherein the step of injecting, into the injection line, the recovered recycled air so as to mix the recycled air with ambient air, is carried out only when the power or current setting is lower than a predefined threshold.

6. A method for managing humidification of air in an air supply of a fuel cell for an aircraft, an air supply circuit of the fuel cell including an injection line, an intermediate line passing through a cathode, and an evacuation line, the air flowing in a predefined direction in the air supply circuit, passing successively through the injection line, the intermediate line and the evacuation line,
the method including steps of:
recovering the air, referred to as “recycled air”, from the fuel cell, in the evacuation line,
injecting into the injection line the recovered recycled air so as to mix the recycled air with ambient air,
increasing a ratio of recycled air relative to ambient air in the injection line when a voltage supplied by the fuel cell reaches or rises above a maximum authorized voltage limit, and
reducing the ratio of recycled air relative to ambient air in the injection line when the voltage supplied by the fuel cell falls below a maximum authorized voltage limit.

7. The method according to claim 6, wherein injecting the recycled air into the injection line is done at an inlet of a compressor located on the injection line.

8. The method according to claim 6, wherein injecting the recycled air into the injection line is done between two stages of a two-stage compressor, said compressor being located on the injection line.

9. The method according to claim 6,
wherein the injection line includes a humidifier configured to allow an exchange of water between the air flowing in the evacuation line and the air flowing in the injection line, and
wherein the step of injecting, into the injection line, the recovered recycled air so as to mix the recycled air with ambient air, is carried out only when a voltage supplied by the fuel cell reaches or rises above the maximum authorized voltage limit.

10. The method according to claim 1,
wherein the injection line includes a humidifier configured to allow an exchange of water between the air flowing in the injection line and the air flowing in the evacuation line,
wherein the step of recovering the recycled air in the evacuation line is carried out downstream of the humidifier on the evacuation line, and
wherein the step of injecting, into the injection line, the recovered recycled air so as to mix the recycled air with ambient air, is carried out only when a voltage supplied by the fuel cell reaches or rises above a maximum authorized voltage limit.

11. An air supply circuit of a fuel cell for an aircraft, the supply circuit being configured to humidify the air supplying the fuel cell, the air supply circuit including:
an injection line,
an intermediate line passing through a cathode of the fuel cell, and an evacuation line,
the air flowing in a predefined direction in the supply circuit, passing successively through the injection line, the intermediate line and the evacuation line,
the air supply circuit additionally including a line, referred to as “recirculation line” including:
a first end connected to the evacuation line so as to recover the recycled air, coming from the fuel cell, and
a second end connected to the injection line, so as to inject, into the injection line, the recovered recycled air and mix the recycled air with ambient air,
the air supply circuit being configured to increase a ratio of recycled air relative to ambient air in the injection line when a voltage supplied by the fuel cell reaches or rises above a maximum authorized voltage limit, and
wherein the supply circuit is configured to reduce a ratio of recycled air relative to ambient air in the injection line when the voltage supplied by the fuel cell falls below the maximum authorized voltage limit.

12. The air supply circuit according to the claim 11, additionally including:
a first flow controller, located on the recirculation line, to control a flow rate of the recycled air, and
a second flow controller, located on the injection line before the second end of the recirculation line with respect to the predefined air flow direction, to control the flow rate of the ambient air.

13. The air supply circuit according to claim 11, wherein the injection line includes a compressor of ambient air, the second end of the recirculation line being connected to the injection line before an inlet of the compressor of ambient air.

14. The air supply circuit according to claim 11, wherein the injection line includes a compressor of ambient air with two stages, the second end of the recirculation line being connected to the injection line between the two stages of the two-stage compressor of ambient air.

15. The air supply circuit according to claim 11,
wherein the injection line includes a humidifier configured to allow an exchange of water between the air flowing in the evacuation line and the air flowing in the injection line, and
wherein the recirculation line includes a valve, the valve being open only when the voltage supplied by the fuel cell reaches or rises above the maximum authorized voltage limit.

16. The air supply circuit according to claim 11,
wherein the injection line includes a humidifier configured to allow an exchange of water between the air flowing in the injection line and the air flowing in the evacuation line, and
wherein which the first end of the recirculation line is located downstream of the humidifier, the recirculation line including a valve, the valve being open only when the voltage supplied by the fuel cell reaches or rises above the maximum authorized voltage limit.
